(19) United States
(12) Patent Application Publication
(10) Pub. No.: US 2017/0245679 A1
(43) Pub. Date: Aug. 31, 2017

(54) Wireless Heat Devices

(71) Applicant: Aaron Watts, Spokane, WA (US)

(72) Inventor: Aaron Watts, Spokane, WA (US)

(21) Appl. No.: 15/513,297

(22) PCT Filed: Sep. 29, 2015
(86) PCT No.: PCT/US15/52908

§ 371 Date: Mar. 22, 2017

Related U.S. Application Data
(60) Provisional application No. 62/180,475, filed on Jun. 16, 2015.
(60) Provisional application No. 62/063,013, filed on Oct. 13, 2014.
(60) Provisional application No. 62/056,810, filed on Sep. 29, 2014.

(51) Int. Cl. A47J 36/24; A23L 2/46; H05B 6/12

(52) U.S. Cl. CPC A47J 36/2444; H05B 6/1236; A23L 2/46; A23V 2002/00

(57) ABSTRACT

Various embodiments of the present technology generally relate to wireless heat devices (“wireless heating devices”). More specifically, some embodiments relate to disposable devices, designed for the conversion of oscillating magnetic field energy directly into thermal energy, without a battery storage medium or intermediary. Described are devices being used to directly convert magnetic field energy into thermal energy for the purpose of heating target surfaces.

### CROSS-REFERENCE TO RELATED APPLICATION

The present application claims priority to and benefit from U.S. Provisional Patent Application No. 62/056,810 entitled “Inductive Sticker” filed on Sep. 29, 2014, U.S. Provisional Patent Application No. 62/063,013, entitled “Disposable Inductive Heating Pad Or Sticker” filed on Oct. 13, 2014, and U.S. Provisional Patent Application No. 62/180,475, entitled “Flexible Printed Wirelessly Powered Resonant Receiver Heater Or ‘Wireless Heat Sticker’” filed on Jun. 16, 2015, the entire content of each of which is herein expressly incorporated by reference for all purposes.

### TECHNICAL FIELD

Various embodiments of the present technology generally relate to wireless heating. More specifically, some embodiments relate to wireless heating devices for targeted resonant inductive heating of consumer products, such as, but not limited to disposable paper cups.

### BACKGROUND

Selective target heating has been a long sought-after goal in nearly every heating related industry to date. Induction heating was a great step forward in accomplishing this goal. Induction heating allows for the direct heating of metals and other electrically conductive materials, while other materials around these electrically conductive materials remain cool. This also allows for electrically conductive materials embedded in other objects to be heated, while the non-conductive layers of those objects remain cool. However, this type of heating suffers from poor controls, as all electrically conductive materials within the magnetic field will heat. The need to direct heat to specific areas within a target object or surface remains a difficult prospect. General induction heating also requires the use of bulky transmitting coils, within which target materials must be placed. This leads to many logistical problems resulting in the improbability of consumer market use. The ability to precisely heat a target material, embedded or not, while ignoring surrounding materials, including other electrically conductive materials is the next step forward in the heating industry because it allows for a broad range of useful heat producing devices.

### SUMMARY

Various embodiments of the present technology generally relate to wireless heating. More specifically, some embodiments relate to wireless heating devices for targeted resonant inductive heating of consumer products, such as, but not limited to, disposable paper cups. In some embodiments, the wireless heating devices may include one or more of the following components: a magnetically susceptible and/or electrically conductive material (e.g., in the form of a thin inductive heating element), trace, inductor, resistor, capacitor or other electronic component; a potential adhesive layer that allows for the adhering of the wireless heating device to the exterior or interior surfaces, or in between the surfaces, of containers or any target item that makes use of directed thermal energy production; a suitable substrate; a protective coating or laminate; or many other combinations of components and materials.

Some embodiments of the disclosed technology can implement recent developments in ‘thin foil’ or etched foils, conductive inks, and printed flexible electronics. Different applications of the technology allow for numerous combinations and variations in the design, including those of size, adhesive formulation, component selection, thermal insulation, heating element composition, and heating element protection material. The design of wireless heating devices according to various embodiments may provide fixed resistance or a specific Curie temperature that sets a maximal temperature attainable within the heating element so that increasing the strength or amplitude of the alternating magnetic field will fail to increase the thermal output of the wireless heating device. Some embodiments of the wireless heating devices may also include many components of variable resistance, such as positive temperature coefficient materials. The body of a target surface may contain wireless heating devices directly within it, in numerous variations, to allow a single unit of operation providing the same functionality as the adhesive version of a wireless heating device.

In some embodiments, the wireless heating devices described are for adherence to, or manufacture within, the raised or flat bottom, or exterior or interior walls, of common paper or plastic containers. Because many wireless heating device designs are disposable, they may be sold at point of purchase with or within each container, or purchased in packs to be carried and distributed as desired. In various embodiments, the wireless heating device may be designed to adhere to the exterior of the container and therefore protect the contents of the container from outside contamination. This method of exterior adherence may protect the user from having to place or remove the potentially hot element from the hot contents of the container. As various embodiments of wireless heating devices are disposable, removal of a potentially hot element may not be an issue as it is merely disposed of with the container.

Another potential protective mechanism used by some embodiments would be the addition of a thermal insulator as the backing layer for this embodiment of a wireless heating device. This thermal insulator can direct the heat produced away from any potential sites of contact the user may encounter with the device and into the target container. These mechanisms together can allow for an effective, sanitary, and incredibly safe method for heating paper or plastic containers, which are generally not considered heatable. In some embodiments, environmental conditions (e.g., temperature, humidity, number of expected uses, safety requirements, and the like) can determine the adhesive or material used in the wireless heating device. The various embodiments described above are a few potential uses for a wireless heating device. Numerous other applications exist by merely changing the dimensions and composition structure of the wireless heating device and its materials.

In simplest form, some embodiments are a layered system, and can be comprised of a thin inductive heating element (e.g., carbon, iron, or any electrically conductive material), a potential protective laminate or coating for that element (e.g., polyethylene terephthalate (PET), polyimide (KAPTON), low density polyethylene (LDPE), high density polyethylene (HDPE), and many others), a potential thermal insulator (e.g., cardboard, paperboard, plastic, or any other thermally insulating material), and a potential adhesive material (e.g., acrylic, polymer, cyanoacrylates, and many other adhesive materials), for adhering the device to surfaces or containers (particularly disposable paper or plastic containers) or for potential manufacturing into said disposable containers.

In a more complex form, some embodiments are a layered, and can be comprised of a printed (e.g., screen printed) system potentially including: a printed or etched conductor, for example silver inks, copper oxide inks, carbon inks, copper foil, silver foil, gold foil, aluminum foil, iron foil, iron oxide foil, or copper oxide foil, serving as a receiving antenna, seated on a substrate (e.g., polyethylene terephthalate (PET), polyimide (KAPTON), polyethylene (PE), low density polyethylene (LDPE), or high density polyethylene (HDPE)), a resonant capacitor (e.g., screen printed or surface mounted), a resistive heating element, such as a positive temperature coefficient ink resistor or iron foil, carbon ink, or carbon steel foil, with potential inter-digitized leads, for example silver ink inter-digitized leads, for modifying resistance of the heating element, a protective laminate layer or functional coating such as polyethylene terephthalate (PET), polyimide (KAPTON), low/high density polyethylene (LDPE/HDPE), and an adhesive material, for example epoxy adhesives, urethane adhesives, methacrylate adhesives, cyanoacrylate adhesives, rubber adhesives, polyvinyl acetate adhesives, acrylic adhesives, polymer adhesives, and many other types of adhesives, for adhering the device to surfaces or containers (particularly disposable paper or plastic containers).

In various embodiments, the device can be a layered, printed (e.g., screen printed) system, comprised of a printed conductor, serving as both a receiving antenna (inductor) and resistive heating element (e.g., copper inks, silver inks, carbon inks, and many other inks) on a substrate (e.g., PET), a resonant capacitor (e.g., screen printed or surface mounted), a protective laminate layer or functional coating (e.g., PET), and an adhesive material (e.g., acrylic adhesive) for adhering the device to surfaces or containers (e.g., disposable paper or plastic containers). In some embodiments, the conductive material can serve as both the antenna (inductor) and resistive heating element, and it may be a self-limiting PTC material, so to self-limit its heating abilities to a specific temperature target. This can be accomplished by using a material with a higher resistivity than standard solid copper. Note that conductive inks can have higher resistance than solid conductors of the same material. Therefore, materials such as copper or silver ink may also be used as heating elements. For example, the inductor coil (antenna) itself can create heat through electrical resistance while still obtaining a resonant frequency specified by the inclusion of its tuning capacitor.

Additional functions and components may include, but are not limited to, passive or active communication and identification of circuits. These may operate on existing platforms such as RFID or NFC or on their own separate frequencies. The purpose of these identification circuits may range from, but are not limited to, customer engagement purposes and transmitter/receiver communication protocols for product safety and identification.

The circuit may also include a thermal management system to identify and control the temperature of the heating element. In some embodiments, a positive temperature coefficient (“PTC”) thermal fuse increases in resistance at a given temperature to prevent the flow of current and prevent additional heating. The heating element itself can also be a PTC material, which can create a self-limiting heating element in which resistance rises at a given temperature to limit current. Transistors that switch current away from the main heating element at a specified temperature may also provide thermal management. In some embodiments, all of these methods may also provide thermal management by blocking current to the capacitor. For example, this could drop the entire circuit out of resonance, thereby decreasing the amount of available current.

In some embodiments, the inductor can be composed of PTC materials. One advantage of using PTC materials for the inductor is that a magnetic field receiving antenna (“Rx” or “receiving device”) (“inductor”) can also serve as a self-regulated heating element. The combination of these three qualities (inductor, resistor, temperature regulator) into a single component can be a step in reducing cost per unit.

In some embodiments, the addition of a PTC material into a wireless heating device can provide an additional mode of communication between the transmitter (“Tx” or “transmitting device”) and Rx (“wireless heating device”). The rise in electrical resistance that can occur at a specific point of heating in the PTC material is detectable by the Tx measurements of load impedance. This can allow the Tx to ‘turn down’ or decrease power output and adjust for the temperature change. This can add another layer of safety in the heating of disposable containers and other non-conventional target surfaces. In some embodiments, using PTC materials as a mode of communication can reduce the cost of wireless heating devices. In some embodiments, a negative temperature coefficient (“NTC”) material, where a drop in resistance can occur at a specific temperature, can inversely implement the same method of communication described above using a PTC material.

In some embodiments, a user may adhere a wireless heating device with an exposed element to a containers inner cavity walls or bottom prior to any contents being added to the container. While this technique offers the same benefits as described above in addition to providing a direct form of contact between the heating element and the liquid or surface to be heated. The direct form of contact can carry the benefit of energy efficiency through the reduction of thermal insulation due to the lower risk of exposure to direct human contact; it is also less costly to produce.

In various embodiments, a user may remove the adhesive layer, and manufacture the wireless heating device, along with the potential laminate protection and insulation layers, directly into the bottom or walls of, for example, a paper cup. In some embodiments, manufacturers may create cup-blank rolls with wireless heating devices embedded within them for the purpose of directly installing the wireless heating device into the paper cup body upon manufacturing the cup itself. As the roll comprising of the wireless heating device moves a runner, a specially-shaped die punches out the bottoms, or walls, of the disposable paper cups to later be combined further down the manufacturing line. This process can reduce costs for retailers and end users while still allowing users the benefits of wireless heating devices without the need for purchase of the extra materials (primarily adhesives and extra thermal insulation) needed when the wireless heating devices are sold separately from the disposable cups.

In various embodiments, the exposed or uncoated wireless heating devices' heating element may lie within the internal bottom of the cup cavity and can allow for direct contact between the thin heating element, for example an aluminum foil heating element, and the liquid or food to be heated. This can allow the manufacturer to remove the polyethylene paper coating from the bottom of the paper cup, providing greater savings on materials cost. Commercially, retailers can label products as unique potentially increasing their consumer base because of the cups' additional functionality. For instance, many café locations have begun to adopt wireless induction technology for charging mobile phones. In various embodiments, the addition of specific software to existing wireless chargers on the market can allow existing wireless chargers to connect to wireless heating devices, providing heat to the consumer's target device and thereby taking advantage of the existing consumer market infrastructure.

Various embodiments also provide for a method for determining the type and materials for the wireless heating device. For example and contrast, a large coffee company and a large industrial manufacturer each request a wireless heating device. The large coffee company requests a cheap, disposable, adhesive, and relatively small wireless heating device for use in coffee distribution for heating paper cups of coffee or tea, with a temperature limit of 60° C. to 65° C., FDA Food Contact Safe materials, and customer engagement advertisements printed on the units. In contrast, the industrial manufacturer requests a large sized, durable wireless heating device for heating large vacuum sealed vats, with a temperature limit of 300° C., with no required FDA approvals. The large coffee company's desired attributes allow the engineer to select appropriate substrates and laminates.

As the large coffee company has selected 60° C.-65° C. as its temperature limit, with low cost and FDA approvals being required qualities, Polyethylene Terephthalate (PET) may be the appropriate substrate and laminate coating. The industrial manufacturer, however, has a much higher temperature requirement, 300° C., making PET an unsuitable substrate for the industrial manufacturer's application. The engineer can select a Polyimide substrate and laminate, with temperature resistance of 350° C.+, for the industrial manufacturer. The engineer can then select the proper adhesive for the large coffee company. The large coffee company has a requirement of FDA approved materials in this case and a water based acrylic adhesive may best meet these requirements. The engineer can then begin selecting appropriate circuitry to meet the requirements of each customer. A primary requirement of the large coffee company is low cost per unit. The engineer can select an electrically conductive ink that helps meet these requirements for printing the conductive traces of the inductor, capacitor, and heating element.

In this example, the engineer may choose copper oxide ink for the large coffee company, as the cost of this ink is less than silver inks at the time of writing of this example, while still maintaining acceptable resistance levels. Conductive silver ink, or an etched foil, may work best for the industrial manufacturing client, as their application requires greater energy expenditure, and in this case, a higher quality, low resistance conductive material. These conductive inks can be screen-printed to form the final dimensions of the circuitry required for each application, in both of these examples that includes the inductor, capacitor plates, and resistor leads. The engineer can then select proper heating element materials. In this example the engineer can select a Positive Temperature Coefficient (PTC) ink for the large coffee company's requirements, which can function as a self-limiting heating element.

A rise in resistance in the PTC material at a pre-chosen temperature can prevent further heating of the PTC ink. The PTC ink chosen can match the large coffee companies requirement for a 60° C.-65° C. temperature limit. The engineer can then chose a heating element can for the industrial manufacturer. The industrial manufacturer requires a higher temperature and energy expenditure. In this example, the same silver ink that forms the inductor and capacitor plates can form the heating element. Electrical resistance in silver inks can be sufficiently high to create heat when electrical current is applied. In this example, varying Tx current input to the wireless heating device and monitoring the temperature of the vat can provide control over the required temperature limits. The engineer can then choose the proper dielectrics for the capacitors of each device. In this example Dupont 5018 dielectric ink will function for both companies to make up the capacitor dielectric. The engineer can then print and test devices. In the case of the large coffee company, the engineer can then send the approved devices to graphics printing for the addition of marketing materials to the wireless heating devices surface. The finished and approved devices are now ready for shipment to the large coffee company and the industrial manufacturer.

Note that a wireless heating device can use various combinations of layering to create devices to heat containers or any target surface. In some embodiments, one may expose the wireless heating device's heating element to the internal cavity of the surface to be heated. In some of those embodiments, this takes place by adhering the wireless heating device to the inside walls or bottom of the cup. In other embodiments, one manufactures the same exposed wireless heating device's element directly into the bottom or walls of the cup itself. In various other embodiments, a topside adhesive adheres a wireless heating device manufactured with layers of insulation to the outer walls, or bottom, of the cup for directional guidance of thermal energy through the cups exterior via thermal conduction and into the interior cavity of the cup. Simple changes in manufacturing can open up numerous application possibilities of the same devices, many of which may lie outside the standard food and beverage warming markets.

Note that while the primary example of a target surface has been paper cups, nearly any container, disposable or otherwise, in which the addition of heat is required, could be used interchangeably. This is true of nearly any target surface, container or not.

Various embodiments of wireless heating devices can include varying circuitry. In some embodiments, the resonant circuit can be a parallel resonant circuit or a series resonant circuit. In some embodiments, the load may be attached across numerous components in series or in parallel. In some embodiments, the heating element can contain inter-digitized conductive traces in nearly any imagined pattern. In some embodiments, there can be numerous capacitors, some in series and others in parallel, to accomplish numerous tasks. In some embodiments, there can be varying types of resistors in numerous circuit positions to accomplish different tasks. None of the examples of circuitry are meant to be limiting, and it should be noted that slight changes to components, component position, and component value produce numerous variations of results that can be specified to a task. All of these devices, however, still fall under the definition of wireless heating devices.

The addition of secondary technological controls, such as RFID/NFC circuitry may be useful when attempting to identify and gather information on the locale and temperature of the system. In many cases, RFID/NFC tags can alert the power unit that the heating device is present. This can allow for the power to be turned off to the Tx that generates the alternating magnetic field when the RFID/NFC tag is not within the scope of the magnetic field. A wireless heating device can incorporate these standards of communication technology in numerous ways. This same communication technology can also be of great use in communicating with customers and providing avenues of customer engagement for everyone in the product chain. The inclusion of RFID/NFC in this description is not meant to be limiting. Many other communication technologies and protocols exist, such as Bluetooth, Bluetooth LE, Wi-Fi, as well as many others. Examples of other uses of wireless heating devices include, but are not limited to, frost protection barriers, equipment freeze protection, water sterilization, pet house heating, clothing/footwear heating, hand-warmers, lab/research equipment, water heating, and snow/ice melting. Various other target surfaces for wireless heating devices may include, but are not limited to, consumer products, such as coffee pots, mugs, cups, disposable cups, food containers, as well as surfaces, such as floors, tables, and desktops.

While nearly any Tx device may heat the devised wireless heating devices to some degree, it is advantageous to use the wireless heating devices with Tx devices that have been optimized to meet the functionality of the wireless heating device for a specific purpose. This can allow for safe and optimal use of the wireless heating device in all environments. One may design Tx devices for wireless heating device use only or Tx devices may have multiple settings for different applications, such as wireless charging.

### Example Description Of Physical Wireless Heating Device Circuit

While there are many different possible configurations of the circuitry, such as parallel resonance with parallel load resistance, parallel resonance with series load resistance, series resonance with series load resistance, series resonance with parallel load resistance, and the like, making up wireless heating devices, these examples will discuss the process and physical makeup of the wireless heating devices and not the numerous variations of circuitry layout. Multiple substrates are possible for screen-printing wireless heating devices. In some embodiments, polyethylene terephthalate (PET) is a good choice. Wireless heating devices can be manufactured with many different shapes and sizes of inductors; sometimes multiple inductors may reside on a single device.

In this embodiment, the first layer can consist of the primary turns of the inductor, and the lower layer capacitor plate. The inductor and capacitor plate can be printed with an outer diameter (“OD”) of 2″ on a PET substrate. The trace width of the turns of the inductor would be 0.5 mm with a 0.5 mm trace spacing. With ten turns, this would result in an inductor inner diameter (“ID”) 1.2″. Next, one or more layers of dielectric may be printed over the capacitor plate, as well as the section of the inductor that will contain the inductors conductive return path. At this point, the PTC resistor with an OD of 1″ in the center of the inductor may be printed, and a layer of barium may be printed on the top-side of the capacitors dielectric layers.

Note that the heating element, a PTC in this case, may take on nearly unlimited patterns. Many of these patterns may include inter-digitized electrical leads to achieve specific heating patterns and resistance values. The original conductive ink itself can form the contacts for the PTC heating element, the second (top) plate of the capacitor, and the inductors conductive return. Now that the electronics are complete, a laminating adhesive and a 0.5 mil laminate layer of PET provide protection for the electronics of the wireless heating device. At this point, a company may print any number of graphics on the surface of the PET cover. The finished unit, when placed within range of a properly calibrated Tx, can produce heat directly from the inducted AC current. Choices of circuitry layout and materials can determine the performance of the wireless heating device.

### BRIEF DESCRIPTION OF THE DRAWINGS

The accompanying drawings describe and explain embodiments of the presented technology.

FIG. 1 is a cross-sectional view through a standard paper cup, wireless heating device and Tx transmitter, and shows wireless heating device placement encompassed by a Tx coil while setting on a flat surface.

FIG. 2 is a description of one embodiment of a layered material view of a wireless heating device.

FIG. 3 is an overhead and cross-sectional view of a potential Tx design.

FIG. 4 is a cross-sectional above and below ground view of a pet house, wireless heating device, and Tx coil for pet house warming in cold weather conditions.

FIG. 5 is a cross-sectional view through a standard paper cup with a wireless heating device wrapped into an encompassing sleeve.

FIG. 6 is a cross-sectional view of a finished paper cup with a built in wireless heating device.

FIG. 7 is an overhead view of a paper cup bottom manufacturing roll containing wireless heating devices for manufacturing directly into a paper cup unit.

FIG. 8 is a cross-sectional view of a potential exposed element manufacturing roll for manufacturing the wireless heating device technology directly into a paper cup unit.

FIG. 9 is an overhead view of a flexible, screen-printed, series resonant inter-digitized wireless heating device.

FIG. 10 is a layer-by-layer cut out of a screen-printed wireless heating device.

FIG. 11 is an overhead view of a flexible, screen-printed, series resonant non-inter-digitized wireless heating device.

FIG. 12 is a cross-sectional view of a resonant resistive inductor wireless heating device used to replace existing metal pots and pans used on induction cooktops.

FIG. 13 is a cross-sectional view of a standard kitchen countertop, under-counter Tx transmitter, devised pan with wireless heating device technology, disposable coffee cup containing a wireless heating device, and electronic device such as a smart-phone, laptop, or tablet containing wireless charging technology.

The drawings are not necessarily to scale. Similarly, some components and/or operations appear in different blocks or in a single block for purposes of discussion. Moreover, while the technology is amenable to various modifications and alternative forms, specific embodiments appear in examples in the drawings and in detailed descriptions below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Various embodiments of the present technology generally relate to wireless heating. More specifically, some embodiments relate to wireless heating devices for targeted resonant inductive heating of consumer products, such as, but not limited to disposable paper cups. In accordance with various embodiments, components of the wireless heating devices may adhere to, or be manufactured within, any target surface in which heating is desired but where a wired element is inconvenient, potentially dangerous, or unfeasible.

The primary use of resonant electromagnetic induction in the consumer electronics world has been to charge electronic device batteries wirelessly. This can require many separate systems to convert and monitor electricity from the transmitting AC current to the useable DC current for charging a battery. Such systems typically strive for high efficiency in electrical energy transactions to reduce unwanted heating of the devices. To further increase the efficiency of these transactions, the devices can be tuned to minimize electrical resistance in the Rx.

Other examples of existing resonant technology include Near Field Communication (NFC) and Radio Frequency Identification (RFID). However, like the previous example, these technologies can require sophisticated microchips or complex circuitry to change AC current to DC, read and encode data, and properly communicate with the Tx or interrogator. These devices, like those mentioned above, strive for efficiency in the form of the least resistance, and highest resonant quality factor (“Q”), possible.

In contrast, various embodiments of the present technology strive to accomplish the exact opposite. By introducing sources of resistance, some embodiments can directly utilize the incoming AC energy to produce a desired product—heat—without the need for complex rectifying circuitry, antenna design, and monitoring components. Unlike these described devices, wireless heating devices strive to be in-efficient, meaning they use resistance to produce work, or, heat. This may sound like a step backwards, or simplification of existing technologies. Instead, however, it is a completely different arena of design and application. The successful application of wireless heating device technology requires breaking new ground and significant research and development in the fields of flexible printed electronics, conductive inks, printed components, adhesives, adhesive films, thermal inertia, thermal conductivity, as well as the development of previously un-researched methods of low cost communication and temperature-monitoring technology, and many other areas of subject matter.

Various embodiments of wireless heating devices depart from general consumer induction heating electronics, such as induction stovetops. Instead, these wireless heating devices can incorporate RLC (resistor, inductor, and capacitor) resonant circuits to further increase conversion efficiency and give the user a greater freedom of position for the Rx device. This can free the user from the general constraints surrounding induction stovetops, primarily, a lack of versatility given the units immobility. This can also allow many Rx devices to be designed for numerous and very specific heating applications by increasing control over which components of the Rx are to produce heat. This is opposed to an inductive stovetop, which heats a simple metal pot/pan nearly uniformly, and without narrow bandwidth considerations, at very close proximity to the transmitting magnetic field. In the case of wireless heating devices, the Rx may be designed to specifically guide the inducted current to desired heating sections. This can allow for the highly customizable application of the technology to nearly limitless consumer designs and applications.

The advent of large flexible printed electronics manufacturing operations has recently made possible the more complete realization of wireless heating devices. Screen-printing electronic devices on flexible substrates, such as for wireless heating devices targeted to disposable cups, is a very new industry. Many groups are striving to develop technology in this field to bring ever more complex electronic systems to the consumer market. However, to date nearly all printed electronic systems are not considered ‘performance,’ simplified to ‘high power’ electronics. Many of the wireless heating devices described herein, however, fall into the ‘performance printed electronics’ category, in some cases operating at several hundred watts, an industry first. This is made possible through careful materials selection, circuit design, and direct control over the wireless heating device's physical environment. Disposable wireless heating devices, prior to large scale manufacturing of flexible printed electronics, were prohibitively expensive, excluding them from the largest portions of the consumer markets. However, with the realization of scale manufacturing in these technologies, inexpensive and disposable wireless heating devices are now possible.

Screen-printing is not the only effective method for creating flexible printed electronics. Many other printing technologies, such as inkjet and flexographic printing, may be used by various embodiments. These descriptions are not meant to be limited to one specific subset of printing technology.

Numerous types of heating exist today for liquids and foods. The most common means of heating liquids or foods is through thermal conduction and convection. In this resistive electrical heating method, the material to be heated is in direct contact with a wired heating element. This type of heating, however, proves difficult for paper and plastic containers because often the heating element is far too hot for such materials. Several types of warmers exist that attempt to solve this problem by limiting the level of heat output so as to be suitable for ceramic and glass containers, though they remain too hot for paper and plastic containers. This potential solution also runs into difficulty due to the architecture of disposable paper cups or other containers or target surfaces.

In the example of the standard disposable paper cup, the bottom outer rim extends below the flat surface of the bottom of the cup. This architecture prevents the flat bottom of the cup from making contact with the heating pad or warmer and thus prevents effective heating from any type of heating pad or warmer that relies on conduction. This same architectural incompatibility exists widely throughout the consumer markets. Most heating devices cannot be customized, because they are generally large appliances. Various embodiments of the wireless heating devices can be inexpensively customized to nearly any consumer item, allowing consumers to easily carry this mobile heating technology with them, freeing them from complete reliance on immobile appliances.

An alternate method for heating liquids and foods is through electromagnetic inductive heating. Electromagnetic induction heating is the direct heating of a magnetically susceptible and/or electrically conductive material via exposure to an alternating magnetic field. The alternating magnetic field generates a proportional electrical field in the conductor allowing Eddy currents to form and to generate resistive joule heating effects. Wireless heating devices are based on this basic underlying theory. Due to the differing electrical resistances of selected materials, the heat produced can be significant (iron) or nearly non-existent (solid silver, solid copper).

However, the inductance of the conductor will generally (excluding magnetic permeability measurements) be very similar given a similar geometry. As a result, some embodiments can use a material with low electrical resistance, such as copper, and direct the flow of electricity to a higher resistance material, such as iron, carbon, or steel to then produce heat, for example attaching a resistor to a low resistance resonant inductive circuit. This is the same theory upon which all inductive electronics are based, though, in most cases, these electronics are made with the lowest resistance possible to allow for the efficient transmission of electricity to power a battery or other storage system. Along with these effects, magnetically susceptible materials can produce additional heat in an alternating magnetic field via magnetic hysteresis. The magnetic moments in the crystalline structure of the magnetic material resist changes in the direction of the alternating magnetic field and subsequent thermal energy expenditure can be observed. The degree of hysteresis effect is highly dependent upon the material and frequency used. Since most (engineered electrically conductive papers and plastics exist) plastic or paper containers are neither magnetic nor electrically conductive direct inductive heating of the container itself is not possible.

The strength of the coupling between the transmitting and receiving devices affects the efficiency as well as the amount of the power transmitted. Greater efficiencies with low coupling factors result when the Tx and Rx are electrically resonant at the same frequency. This can allow for the effective storage of energy between the electric and magnetic fields. This energy slowly dissipates, and can allow for a greater amount to be captured by the Rx.

There are many benefits to wireless heating devices over those of traditional resistive conduction heating systems. Wireless heating devices do not require that the surface to be heated be in direct contact with a Mains electrical source. This can allow for the heating of materials that are not directly wired into a system. This freedom from the physical constraints of a wired system can be of benefit. In the case of heating liquids, isolation from Mains electrical circuitry can also be a protective benefit as the risk of electric shock is decreased. A further benefit of some embodiments of the wireless heating device is that the magnetically susceptible and/or electrically conductive materials to be heated may be embedded in other materials, removing the potential dangers of burn injury via contact with an exposed heating element. This same method of protection against an exposed heating element can allow for directional guidance of the thermal energy being released from the heating element. Common resistive stovetops lose large portions of their thermal energy into the surrounding environment; while a properly placed wireless heating device has the ability to concentrate heat into only desired heating areas.

To date, most inductive heating systems for the heating of foods and liquids are analogous to older resistive heating systems in their method of use. They generally consist of a flat surface on which a magnetically susceptible and/or electrically conductive material sits in order to be heated. Many times the magnetically susceptible and/or electrically conductive material that becomes hot is in the form of a pan, pot, cup, bowl or other commonly used container designed specifically for use with induction technology (e.g. it is made of a ferrous metal). There are no known existing induction technology options for disposable or reusable paper or plastic containers, including other low temperature materials, and there are many reasons for this. Among the most significant are cost, because large pieces of ferrous metal used in disposable containers would be prohibitively expensive, and heating control, because the addition of monitoring and communication technology to existing devices would require significant research and development, complex installation, and would again be prohibitively expensive.

Wireless heating devices provide a solution to all of these mentioned problems. Conductive ink technology makes possible wireless heating devices that can be inexpensive and considered disposable. They also, as described throughout this text, can incorporate simple, and inexpensive, temperature monitoring and control systems. The design of wireless heating devices allow them to work with a specific group of transmitters (Tx), and therefore the user is not responsible for installing complex custom circuitry to make the technology effective. These improvements make wireless heating devices a step forward for heating technology.

To further explain, most consumer induction heating devices do not work by being in tune, or at the same resonant frequency, with their receivers (e.g., pots, pans, etc.). This can create additional inefficiencies that properly designed receiver units that capture as much energy from the Tx as possible may rectify. In simplest form, this would mean adding a capacitance to the Rx, allowing it to achieve a resonant frequency identical to that of the Tx. This can allow for greater freedom of positioning, which in the case of the consumer can be a useful attribute.

The following description sets forth, for the purposes of explanation, numerous specific details in order to provide a thorough understanding of embodiments of the present technology. It will be apparent, however, to one skilled in the art that all of these specific details are not necessary to implement embodiments of the present technology. While, for convenience, the description here of embodiments of the present technology are with reference to wirelessly heating containers of liquids, embodiments of the present technology are equally applicable to target surface heating applications, clothing/body heating applications, laboratory heating equipment applications, industrial heating equipment applications, such as brazing, melting, and welding equipment, home heating applications, such as floor heating, roof heating, driveway heating, and bathroom heating, medical heating applications, electronic device weather protection applications, general frost/low temperature protection applications, vehicle heating applications, snow/ice melting applications, cooking applications, and various other types of heating applications.

Various embodiments of the techniques introduced here may be implemented as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions for programming a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

### General Description

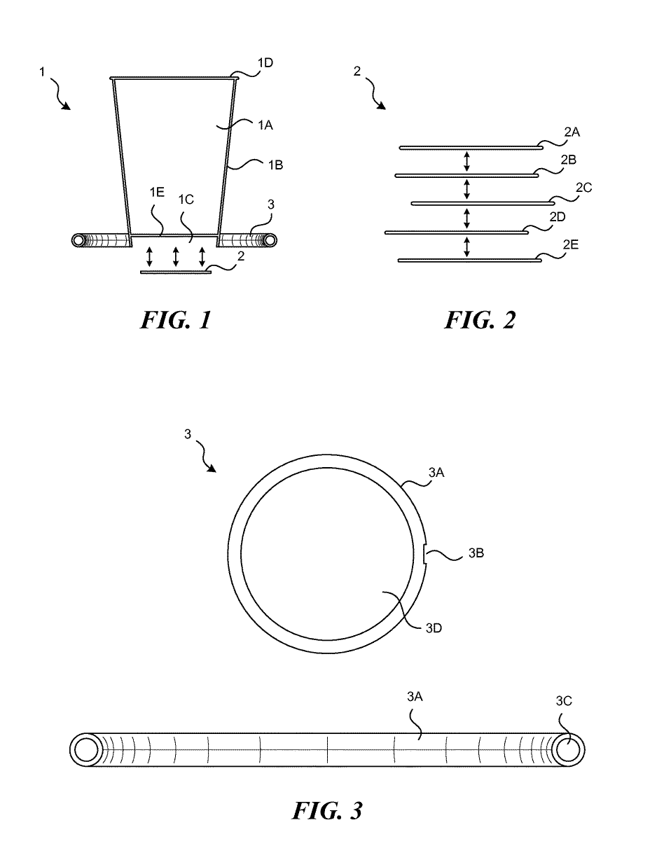

FIG. 1 illustrates a cross-sectional view through a standard paper cup 1, a wireless heating device 2, and a Tx 3. In the embodiments illustrated in FIG. 1, the wireless heating device 2 can reside within the raised space 1C below the paper cup's bottom wall 1E. The wireless heating device 2 may adhere to the paper cup's bottom wall 1E. The paper cup now containing the wireless heating device can sit within the diameter of the Tx 3 where the wireless heating device 2 can convert the created alternating magnetic field into thermal energy via electromagnetic induction, magnetic hysteresis and/or Joule Heating. Thermal conduction can direct the thermal energy through the cup's bottom 1E and into the cup's inner cavity 1A, where liquids and gasses can conduct thermal energy via thermal convection. In the embodiments illustrated, the wireless heating device 2 can have a diameter ranging from 1 cm to 6 cm and a thickness ranging from 0.05 mm to 6 mm. In other embodiments, the diameter and/or thickness may be larger or smaller.

FIG. 2 illustrates a layered material view of a wireless heating device 2. Layer 2A represents the potential adhesive topside and can include a water based acrylic adhesive, of the wireless heating device 2. Numerous adhesive mixtures (e.g., acrylic, polymer, cyanoacrylate) are possible dependent upon the final operating conditions and target materials of the wireless heating device 2. If the wireless heating device 2 resides within a container for direct contact heating, the adhesive layer 2A would no longer represent the topside of the wireless heating device 2. Layers 2B and 2D represent potential laminate layers, such as polyethylene terephthalate (PET), for the purpose of protecting and strengthening the thin heating element layer 2C. Depending on the end use of the wireless heating device, numerous types of laminate layers 2B and 2D may be chosen, such as PET, PE, KAPTON, LDPE, or HDPE.

Various criteria for laminate selection exist. Examples of the laminate selection criteria may include, but are not limited to, tensile strength, sheer strength, adhesive bonding ratio, thermal conductance, electrical conductivity, and temperature resistance. For example, in some embodiments PET is a possible laminate layer. PET is a choice when the following attributes are required: moderate temperature resistance, flexibility, liquid resistance, FDA Food Contact Safe approval, low cost, and wide availability. If a higher temperature resistance is required, one might choose polyimide (KAPTON), which has similar flexibility, liquid resistance, and FDA approvals similar to PET but has a higher temperature resistance and cost factor. Similarly, if a lower temperature resistance is required, one may choose polyethylene (“PE”), which has similar attributes to PET; however it has a much lower temperature resistance and cost.

In many cases, the thin inductive heating element 2C, which in some embodiments may be comprised of resistive inks, such as carbon ink or a positive temperature coefficient ink, or a resistive foil, such as carbon foil, iron foil, aluminum foil, or carbon steel foil, may not require laminate layers for protection. Many times this may be the case with electrically conductive aluminum foil elements. Numerous types of materials are possibilities for the thin heating element 2C. Selection of materials may depend on their electrical conductivity and resistance, heating limits, magnetic susceptibility, magnetic permeability, particle size, workability, and many other criteria. For example, some embodiments may use an aluminum foil element to reduce costs while still providing electrical resistance. In other embodiments, a carbon steel element can be used because of its magnetic properties. The magnetic permeability of carbon steel can allow for a magnetic field of increased strength and can, in some embodiments, increase the efficiency of the element.

In some embodiments, the inductive heating elements may include non-magnetic materials such as graphite, aluminum, and the like. These non-magnetic materials can be candidates for thin inductive heating elements as thin conductive materials can force alternating current into a much smaller area, creating increased resistance and therefore heat. In addition, some embodiments might combine numerous thin heating element materials to meet the demands of the intended use, for example, to have extremely precise and controllable heating patterns as a result of their chemical structure.

Layer 2E can represent a thermal insulator to direct the produced thermal energy towards the target material to be heated. Numerous types of thermal insulators are possible dependent upon the operating temperatures of the thin inductive heating element 2C and the wireless heating device's surrounding environmental conditions. In various embodiments of the previously described use of heating a paper cup, the thermal insulator 2E may have thermal insulation, or lack of thermal conduction, to protect the user from being burned by the thin inductive heating element 2C. If the wireless heating device adheres to the inner cavity of the container, a thermal insulator 2E may not be required as the container itself can provide insulation from the outside environment. In some embodiments of the wireless heating device 2, a single material capable of performing all functions may replace the laminate layer 2D and thermal insulator 2E. All layers of the wireless heating device 2 represent the single, adjoined unit described as the wireless heating device 2.

FIG. 3 illustrates an overhead and cross-sectional view of a potential Tx 3 design. In the embodiments illustrated in FIG. 3, the outer casing 3A can be a toroidal torus ring that houses conductive wires that carry an alternating electric current. The power supply connection port 3B houses the positive and negative current terminals for connection of a power source to operate the Tx 3. Electrically conducting wires may reside in inner casing cavity 3C. The inner perimeter 3D of the Tx 3 may contain an item containing a wireless heating device, which may be set for operation.

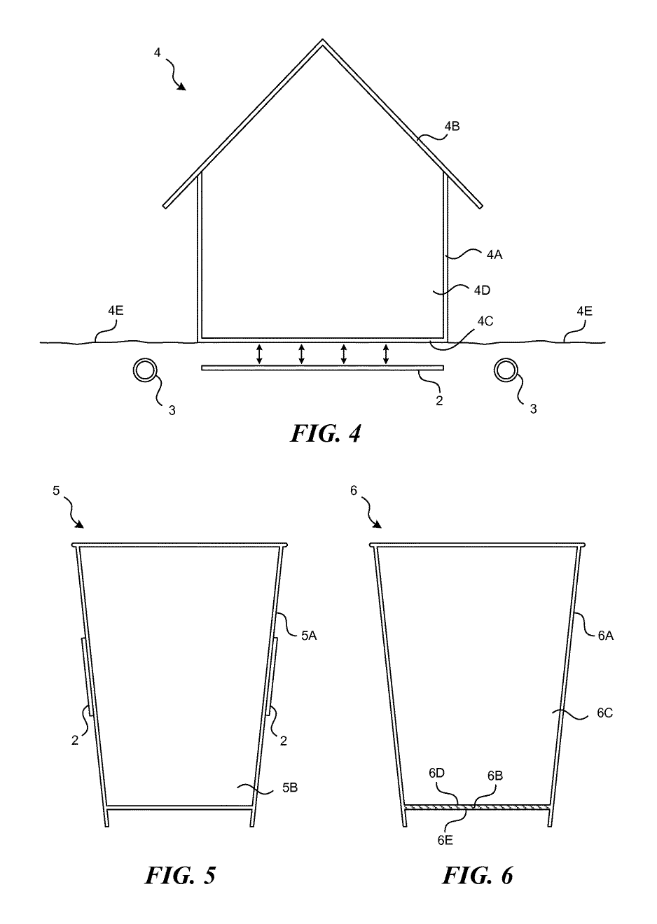

Illustrated in FIG. 4 is a cross-sectional above- and below-ground view of a pet house 4, wireless heating device 2, and a Tx 3. FIG. 4 represents the use of the wireless heating device 2 in pet house 4 for warming. The pet house may have vertical walls 4A, a roof 4B, a floor wall 4C, an inner cavity 4D, and an exterior ground level 4E. A wireless heating device 2 adheres to the exterior bottom wall 4C of the pet house. A Tx 3, buried below the surface of the ground 4E, encompasses the pet house (4) within its inner perimeter.

Illustrated in FIG. 5 is a cross-sectional view of a standard paper cup 5 with a wireless heating device 2 wrapped into an encompassing sleeve. The wireless heating device 2 slides over the outer cup walls 5A to form a sleeve. By placing the paper cup 5 with a wireless heating device sleeve in an alternating magnetic field, the wireless heating device sleeve will direct heat through the outer cup walls 5A and into the cup's inner cavity 5B. In some embodiments, a substrate (e.g., PET, PE, LDPE, HDPE, or KAPTON) can be selected and a screen-printed conductive ink (e.g., silver or copper oxide ink) can be added onto the substrate to form the conductive traces of the inductor, capacitor plates, and heating element leads. In some embodiments the substrate material can be between 0.5 Mils and 5 Mils in thickness. A resistive material, for example carbon ink, positive temperature coefficient ink, aluminum foil, carbon foil, iron foil, or carbon steel foil, can provide the heating element. A dielectric material, such as DUPONT 5018, can provide the dielectric of the capacitor.

The wireless heating device can then be formed onto a mandrel representing the size of the target cups, and may add a layer of thermal insulation, such a cardboard, to the exposed side of the sleeve. The sleeve can then be placed around a common coffee cup and the cup can be placed near a Tx. Energy transfer from the Tx to the wireless heating device may produce heat within the wireless heating devices heating element. This heat moves through the walls of the cup via thermal conduction and into the liquid inside. Thermal convection then transfers heat throughout the liquid. In other embodiments a resistive foil, for example aluminum foil, with a thickness of between 0.5 Mils and 5 Mils, replaces the above mentioned circuit and substrate.

The foil can be wrapped around the mandrel and a thermal insulator (e.g., cardboard) can be added to the exposed side. The sleeve may wrap around a cup and when exposed to an alternating magnetic field, can begin to conduct electricity and produce heat via joule heating. Thermal conduction can direct the thermal energy from the heating element, in this case aluminum foil, through the cup's walls and into the liquid inside the cup, where liquids transfer thermal energy via thermal convection.

Illustrated in FIG. 6 is a cross-sectional view of a finished paper cup 6 with a version of the wireless heating device built into the cup during the manufacturing process. The cup 6 can include the cup body walls 6A; a thin inductive heating element 6B, which includes laminate protection layers, for example a protective layer of PET, and any additional thermal insulation that makes up the wireless heating device manufactured into the paper cup bottoms of the finished paper cup; an inner cavity 6C; a polyethylene- (or other polymer-) coated paper interior cup bottom 6D and exterior cup bottom 6E. In some embodiments, the finished product may be a single unit that consists of a paper cup with induction heating capabilities.

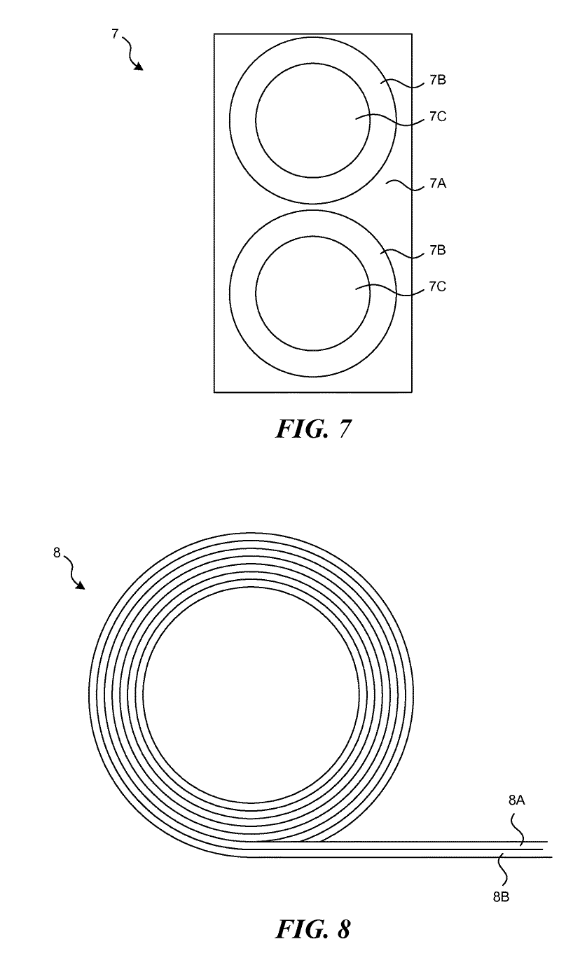

Illustrated in FIG. 7 is an overhead view of a small section of a manufacturing roll 7 of paper cup bottoms. In this view of the manufacturing roll 7 there are two sections shown that can contain the die cut patterns for the cup bottoms. FIG. 7 can include a manufacturing strip 7A. This can be the material that remains after the cup bottoms are punched out of the manufacturing roll 7. In some embodiments, a vertically folded section 7B of the paper cup bottom may be adhered to the body walls over the paper cup in a later manufacturing step. This section may consist of paper stock and generally a polyethylene coating. Section 7C of the paper cup bottom can contain the thin inductive heating element, laminate protection layers of the thin inductive heating element, and any additionally needed thermal insulation.

Illustrated in FIG. 8 is a cross-sectional view of a potential exposed element manufacturing roll 8 for manufacturing the wireless heating device 2 technology directly into a paper cup unit. Electromagnetic induction may heat the interior cavity bottom, or wall, surface composed of exposed element 8A. Paperboard 8B may make up the finished paper cups body. The manufacturing roll 8 moves along a manufacturing line where a specially-sized die punches out the proper paper cup shapes. Because the wireless heating device manufacturing roll 8 already contains the exposed element 8A, the completed paper cup unit can have the added functionality of the wireless heating device 2 without the need for an additional material. This method may provide manufacturers and retailers with savings.

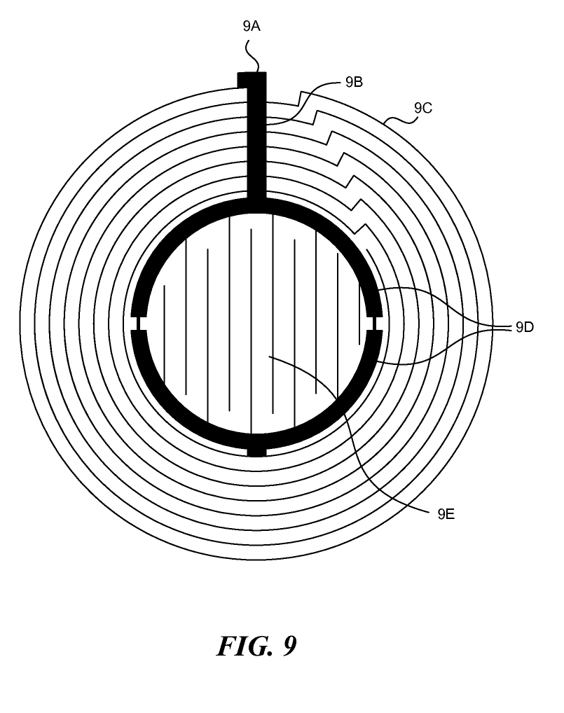

Illustrated in FIG. 9 is an overhead view of a flexible, screen-printed, series resonant, inter-digitized wireless heating device. Here a tuning capacitor 9A may achieve a particular resonant frequency in the series resonant wireless heating device. Tuning capacitor 9A can be composed of two conductive plates printed with conductive inks and two layers of printed dielectric. Electrically conductive ink printed as a current return path 9B completes the circuit. This return path may consist of an electrically conductive ink 9B atop two layers of dielectric, which can separate it from the inductor traces. A wireless heating devices inductor 9C may be added (e.g., screen printed) directly onto the substrate using electrically conductive ink. Electrically conductive ink 9D can form the resistive heating elements leads or contacts. Electrically conductive, screen-printed, inter-digitized tracks 9E may be on a screen-printed PTC resistor being used as a self-regulating heating element.

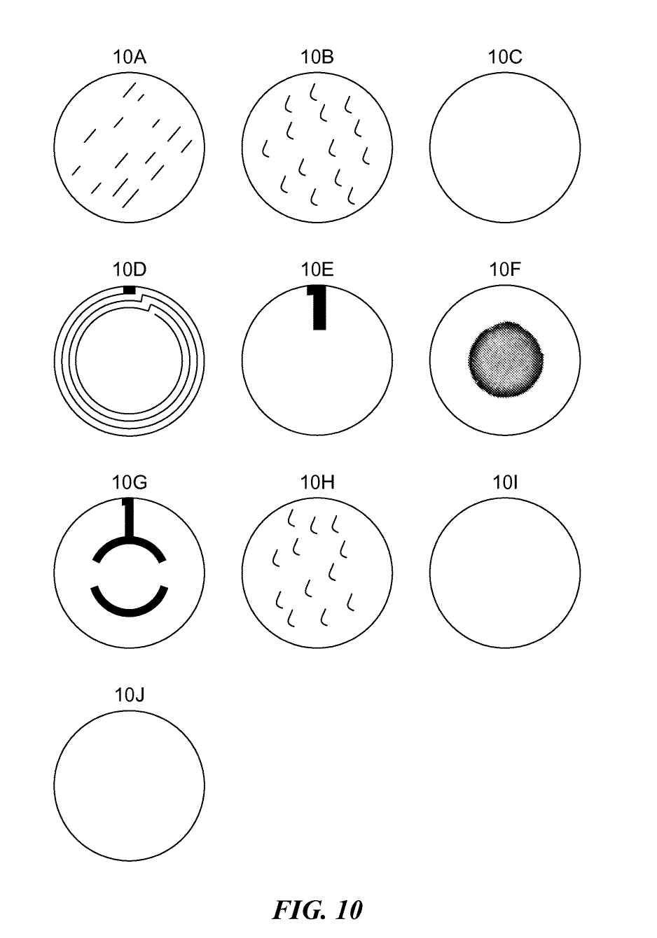

Illustrated in FIG. 10 is a bottom-up layer-by-layer visualization of a screen-printed wireless heating device. Adhesive liner 10A: the diagonal lines represent a material used to protect the wireless heating devices adhesive from contact with unintended surfaces as well as from the environment, including protecting the adhesive during storage; it may be comprised of numerous materials, including most paper and plastic materials. Pressure sensitive adhesive 10B: the curved lines represent a pressure sensitive adhesive material, for example water based acrylic adhesive, used to bond the wireless heating device to a target surface or unit. The wireless heating device's substrate 10C can be comprised of various materials, for example, PET, PE, LDPE, metals, foils, paper, paperboards, and various others materials.

The primary layers of the wireless heating device's inductor as well as one layer of the resonant ‘tuning’ capacitor are shown in 10D. The inductor and capacitor traces may consist of numerous electrically conductive inks, for example silver or copper oxide inks. One or more layers of dielectric 10E can make up the tuning capacitors dielectric as well as the current return path dielectric, which can separate the primary turns of the inductor from the current return path. In some embodiments, other conductive materials such as barium ink are added to the capacitor as a secondary conductive plate to affect the capacitors attributes (e.g. capacitance and equivalent series resistance). Some embodiments may use a PTC resistor 10F as a heating element. 10G shows the PTC resistor leads or contacts, current return path, and final tuning capacitor plate. 10H shows the laminating adhesive, where the curved lines represent various adhesives, for example cyanoacrylate adhesives, acrylic adhesives, or polymer adhesives. The circle 10I can represent a 0.5 mil protective layer of, for example PET. 10I may protect the circuit from outside environments, as well as, act as a substrate for any graphic printing. A graphic printing layer, represented by circle 10J, allows companies or individuals to print any graphics, including logos, onto the wireless heating device.

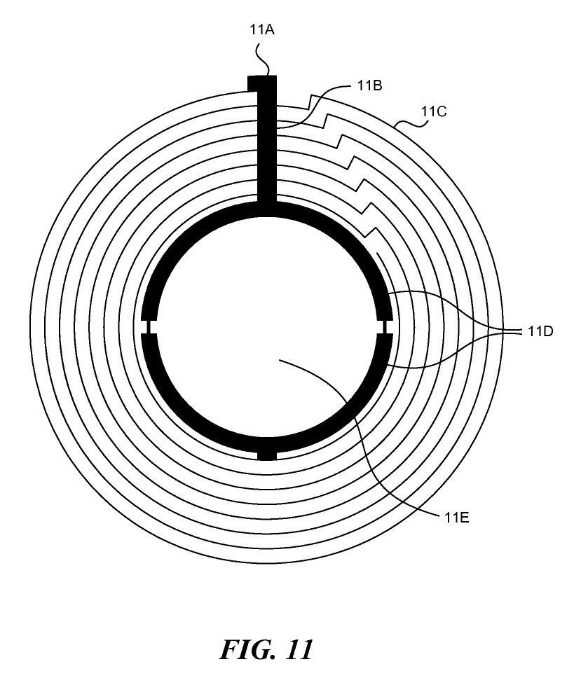

FIG. 11 illustrates an overhead view of a flexible, screen-printed, series resonant, non-inter-digitized wireless heating device. Tuning capacitor 11A may achieve a particular resonant frequency in the series resonant wireless heating device. Tuning capacitor 11A can be composed of two conductive plates printed with conductive inks, and two layers of printed dielectric. A circuit printed of electrically conductive ink 11B can create a return path for the current. This return path can consist of electrically conductive ink atop two layers of dielectric, separating it from the inductor traces. One can screen-print electrically conductive ink 11C directly onto the substrate in the form of the wireless heating devices inductor. Electrically conductive ink 11D can form the resistive heating elements leads or contacts. Electrically conductive, screen-printed, non-inter-digitized resistor 11E can be a self-regulating heating element.

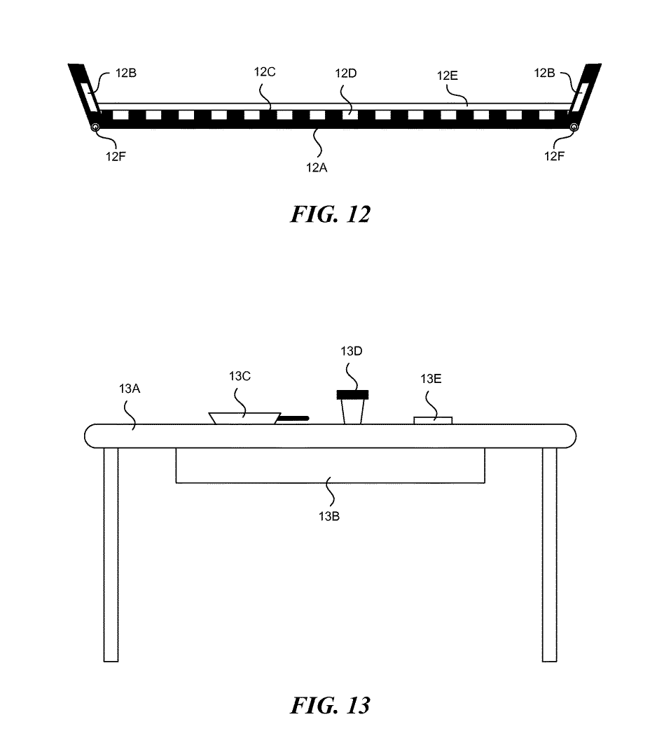

Illustrated in FIG. 12 is a cross-sectional view of a resonant resistive inductor wireless heating device used to replace the existing metal pots and pans used on induction cooktops. The device may consist of an outer performance plastic shell 12A, tuning capacitors 12B, resistive inductor 12C, spacing 12D between the turns of resistive inductor 12C, a thermally conductive heat spreader and cooking surface 12E, and an optional Magnetic Resonance Field Enhancer (“MRFE”) 12F. The turns of the resistive inductor 12C, can perform as both an inductor and heating element. The thermally conductive heat spreader and cooking surface 12E can perform the job of evenly spreading the heat of resistive inductor 12C so as to be useful for cooking. In some embodiments, one may tailor this layer to have significant magnetic susceptibility to increase inductance and shape or guide the magnetic field. The MRFE 12F can magnify, shape, and/or guide the magnetic field. In some embodiments the MRFE 12F can be as simple as a single copper ring.

FIG. 13 illustrates a cross-sectional view of a standard kitchen countertop 13A, an under-counter Tx transmitter 13B, a previously-described pan with wireless heating device technology 13C, a disposable coffee cup containing a screen-printed, disposable wireless heating device 13D, and an electronic device 13E such as a smart-phone, laptop, or tablet containing wireless charging technology. Because the under-counter Tx transmitter 13B can reside beneath the standard kitchen countertop 13A, one does not need to set or cut the standard kitchen countertop 13A, unlike standard limited function stovetops. Because the pan 13C may radiate little to no heat from its outer-surfaces, the standard kitchen countertop 13A can be protected from heat damage, and the user may be further protected from burn injury. Because disposable wireless heating device 13D can be self-regulated, the pan 13C, which has much higher power, may work side-by-side with disposable wireless heating device 13D. The same may be said about the inclusion of electric device 13E. Electric device 13E may work side-by-side with the described wireless heating devices without risk of heat damage. This allows for increased safety and convenience for the user.

### EXAMPLES

An example of wireless heating device use would be in the environment of a coffee shop. One could sell or give away wireless heating devices through partnerships with the owning business organization. A product user could simply peel the sticker from its cover and adhere it to the interior, or exterior, raised bottom of their paper cup, or wrap a sleeve containing a wireless heating device around the exterior, or interior, of the cup. The business would already have placed (or given/sold to customers to place) Tx transmitters designed specifically for the wireless heating devices at tables, in vehicle cup holders, on desktops, or any other surface in which consumers may wish to set their paper cups. By setting the cup within range of a Tx designed for this application, the wireless heating device could then achieve a specific temperature (normally in the vicinity 65° C. for this application) to be conducted from the wireless heating device, through the paper cup and into the liquid, or directly into the liquid if placed within the cup. This could allow customers to keep their drinks warm for any desired length of time without being exposed to the potential dangers of burners or heat pads that are in common use today.

This use of wireless heating devices could also help prevent the practice of putting foreign objects into (or removing foreign objects from) a drink after it has been poured, exposing it to unsanitary conditions, as well as potential spillage and burns in the process. This could allow customers the freedom of not having to carry specially-designed cups, thermoses, or other types of containers, saving them money and allowing them the freedom of being able to apply the technology without carrying multiple pieces of equipment with them at all times. The wireless heating device may represent a new stream of revenue for retailers by providing their existing products with new functionality. This use may also provide extra advertising opportunities, such as retailers printing their logos onto the surface of the wireless heating device.

Another example of use of a wireless heating device would be its application to pet houses in the winter. While many versions of pet house warmers exist, they are all based upon wired electric heating elements. This can create many potential problems. Animals, dogs in particular, may scratch the heating element that has been placed under a cushion in their house, exposing them to potential burn and electric shock. The wireless heating device can adhere to the exterior bottom side of the pet's house and directs heat upwards through the floor. This can keep the heating element safely contained and away from the pet. Because the wireless heating device does not have any attached wires, there is no potential for electric shock from the wireless heating device itself.

Installation of the wireless heating device is simple compared to the existing installation practices of current electric heating systems within a pet house. Simply peeling the sticker away from its backing and applying it to the exterior bottom of the pet housing unit is all that needs to be done to install the wireless heating device. The pet owner may then bury a Tx coil system in the ground or place it in numerous types of protective casings at distance from the pet house.

Another example is the use of a disposable paper cup with the wireless heating device manufactured into the finished bottom, or walls, of the cup. This would allow for customers to adopt the technology without the need to purchase separate products for the benefit of the wireless heating device's functionality. A retailer could offer the finished cups with wireless heating devices previously manufactured into them to customers, potentially giving the retailer a competitive edge, allowing the customer to use the technology by placing the cup itself within range of a Tx. This could further simplify the process of technology usage to the customer. Retailers may offer tables that include Tx transmitters within the retail space for the customers' convenience, potentially allowing customers to keep their beverages warm for the length of their visit. As an example of Tx transmitters used in coffee locales in the present day, Starbucks' has a partnership with Powermat Technologies in which it uses these transmitters for wirelessly charging consumer electronic device batteries.

Another example is the use of wireless heating devices to warm coffee pots. Most existing coffee pot warming systems are simple heating pads. Due to this, they can be inefficient and waste heat to the surrounding environment. A coffee pot, however, could have a wireless inductive heating device adhered to it or manufactured within it. When the pot comes within range of its partner Tx, the wireless heating device can heat to its predetermined parameters, losing less energy to the outside environment and potentially offering more control over heating.

Another example is the use of wireless heating devices in vacuum-sealed containers. Vacuum-sealed containers are one of the primary methods used to control the temperatures of a containers contents. A vacuum seal would generally not allow for the addition of a standard heating element, as this can make a thermally conductive path between the heating element and the outside wiring/powering unit, rendering the vacuum less efficient in insulating the containers contents. However, a vacuum will have no effect on the traversing magnetic field used to power a wireless heating device. A wireless heating device residing within a vacuum-sealed container can function identically to a wireless heating device residing in a non-vacuum sealed container. This can provide energy savings and may have applications in residential and commercial water heaters. To further increase this efficiency, some embodiments include an magnetic resonance field enhancer (MRFE) within the exterior of the container. In some instances this can be as simple as including a copper ring along the outside diameter of the container. This can increase the density of the magnetic field present for the wireless heating device to utilize.

Another example is the inclusion of a wireless heating device to improve upon existing induction stovetop technology by providing a more efficient pot/pan/cooking surface. In this example, a wireless heating device may be placed within a non-electrically conductive (high temperature performance plastic) outer shell. The shell may be vacuum-sealed for further heat direction. The wireless heating device in this example may include a resistive inductor and resonant capacitor. When the shell comes within range of an induction stovetop, the pot/pans interior can heat, while the exterior remains cool. This can allow for increased safety. This may also allow for increased efficiency, as less heat may radiate from the pot/pans outer walls into the surrounding environment.

The inclusion of resonant technology in the wireless heating device may also increase the efficiency of standard induction stovetops. To further increase this efficiency, one could place an MRFE within the plastic exterior of the pan. In some instances, this is as simple as including a copper ring along the outside diameter of the plastic shell. This can increase the density of the magnetic field present for the wireless heating device to utilize. Many different layering choices exist for this embodiment of a wireless heating device. In some cases, the use of magnetically susceptible materials to shape/guide magnetic fields can be beneficial.

Another example envisions the use of a Tx unit paired with multiple wireless heating devices and other Rx receivers. A Tx unit may reside underneath a granite, or other material, kitchen countertop. One can mount the Tx unit as one would mount other Tx units underneath tables, with no need for cuts into the granite (or other material), countertop. In this example, the Tx unit may be the same length and width as a standard stovetop. However, since the unit can reside underneath the countertop, it is not visible. In accordance with some embodiments, the Tx in this example may be programmed to recognize multiple loads, including that of wireless heating devices. The Tx may now heat or charge many items may side-by-side via this countertop arrangement. A cooking pan, disposable coffee cup, and cell phone, tablet, or laptop can simultaneously receive power on the same surface from the Tx. This would not be possible without wireless heating device technology. The wireless heating device cooking pot/pan previously described is integral to the plausibility of this system because the pot/pan wireless heating device's outer surfaces remain perfectly cool, unlike conventional pots and pans, and therefore the granite (or other material) countertop surface can remain protected from heat and undamaged.

In this same example, a wireless heating device is required to heat the disposable paper cup. As mentioned previously, many wireless heating devices have the ability to self-regulate temperature, making the heating of the disposable cup side-by-side with a cooking vessel possible and safe. In this example, the same Tx may also include more advanced pairing protocols, which may provide wireless power to numerous electronic devices, such as smart-phones, tablets, laptops, or nearly any other electronic device containing the proper equipment to receive power via wireless protocols. Benefits of the described system may include the following: safety, since burns are less likely via a lack of exposed burners on the countertop surface or standard pot/pan hot outer surfaces; multiple device use convenience, since heating of nearly any product including a wireless heating device is now possible as well as charging electronics; and home aesthetics, including ease of installation when compared to cutting fittings out of conventional countertops for the limited function standard stovetop. Worth noting also is that the system (Tx and Rx) in this example can perform as truly zone-less. Unlike conventional stovetops (even those stovetops with numerous coils to allow for more dynamic positioning), the Rx in this example may be placed anywhere within the ID of the Tx unit.

In some embodiments, a light emitting diode (LED) can be added to the wireless heating element. For example, an LED can be attached to the heating element, and when the wireless heating element receives electrical or magnetic waves, the LED can illuminate, which indicates to a user that the cup is heating.

In one example of using a wireless heating device, a customer has purchased a wireless heating transmitter that is designed for use with disposable wireless heat devices targeted to disposable paper coffee cups. In this example, the transmitter operates at the Alliance For Wireless Power wireless charging frequency of 6.78 Mhz. In this example, the transmitter is a zero voltage switching Class D amplifier utilizing Gallium Nitride transistors. An on-board mains rectifier and DC-DC converter (to achieve proper voltage and current controls) power the amplifier. In this example the transmitter, when at full power, is operating at 60 Volts and 0.85 Amperes. The customer orders a cup of coffee from the retailer and requests that a wireless heating device be included. The coffee shop employee adheres the wireless heating device to the inside bottom of the disposable paper cup prior to filling it with coffee. The employee may then fill the disposable paper cup with the customers requested beverage.

The customer can then place their disposable paper cup containing a wireless heating device within range (e.g. within the perimeter of the Tx's transmitting coil) of the power-transmitting unit. The transmitting unit sends out an interrogation pulse measuring for the appropriate load, in this case the wireless heating device. The transmitter can detect the wireless heating device and full power is activated. The alternating magnetic field, resonating at 6.78 Mhz, causes the wireless heating device, which has also been tuned to resonate at 6.78 Mhz, to induct energy from the magnetic field generating a proportional current in the wireless heating device. The wireless heating device guides the inducted current into the wireless heating devices resistive heating element. The heating element heats via resistive joule heating. In this example, the resistive heating element is comprised of a Positive Temperature Coefficient resistive ink. The temperature of the resistive heating element rises and the wireless heating device can conduct heat into the liquid in the cup. Through convection, heat is then transferred throughout the liquid in the cup. The temperature of the heating element reaches a pre-selected maximum temperature, in this example 65° C., as governed by the PTC material, resistance in the ink rises reducing current flow and preventing further heating in the wireless heat device. The amplifier control circuitry identifies the rise in resistance (i.e. a rise in impedance) and reduces power output. The customer can keep their beverage at the selected temperature indefinitely when within range of the powering transmitter.

Note that while nearly any frequency may function in wireless heating device design, there are some frequencies that may have benefits over others, for example, the frequency being used by the Alliance For Wireless Power (6.78 MHz) for wirelessly charging electronic device batteries. This frequency standard has many benefits, including: low Specific Absorption Rate (SAR) values, increased tolerance to interference caused by nearby metal objects, existing research on the effects of 6.78 MHz frequencies on the surrounding environment, and existing available infrastructure (for example, many people already have wireless chargers operating at this frequency, potentially allowing for cross-integration of wireless heat devices with existing equipment). In addition, induction cooktops generally operate in the 20 KHz-75 KHz range. This frequency is another example of existing market infrastructure from which wireless heat devices can benefit. While this frequency may be less effective for wireless heating devices designed for paper coffee cups (i.e. the capacitors required for significant heating at this frequency can be large and prohibitively expensive for thin disposable devices), wireless heating devices designed to replace existing induction cooktop cookware could benefit from operating at this frequency range, as existing infrastructure could be utilized.

As frequency increases the size requirements for the resonant capacitor decrease. This can be a useful tool when designing a wireless heating device for a specific application. If the wireless heating device is required to be small, or thin, higher frequencies can then be a beneficial selection. In some embodiments, one can design the wireless heating device to operate at 13.56 MHz, a frequency in the Industrial, Scientific, and Medical (ISM) bands currently used by the Near Field Communication (NFC) platform. This can allow the designer to benefit from existing market infrastructure by potentially allowing existing devices to integrate with the function of the wireless heating device, especially for communication protocols assigned to the wireless heating device. For example, a wireless heating device designed to resonate at the ISM band, NFC frequency of 13.56 MHz could incorporate communication protocols that can operate from the same antenna and resonant circuitry as the wireless heating device. This can allow for added functionality, including increased Tx-Rx communications and various methods of customer engagement, while simultaneously integrating with existing NFC communications equipment, for example, a smartphone with NFC reading capabilities. In other embodiments, other WiFi frequencies such as, but not limited to, 2.4 GHz, 3.6 GHz, 4.9 GHz, 5 GHz, and 5.9 GHz may be used. Engineers are currently conducting research into using the existing WiFi communication frequency bands to wirelessly transfer power to electronic devices, for example, smart phones. As industry develops this technology, the power density of the carrier signal may increase. One may design wireless heat devices to benefit from these structures by being resonant at the WiFi devices transmitting frequency. For example, a wireless heating device designed to operate (resonate) at 5.9 GHz may effectively receive power from the transmitting WiFi device, and can produce heat. This same setup can allow for the wireless heating device to take advantage of its existing resonant circuitry as a method of communication with other devices designed to communicate at the WiFi frequency of 5.9 GHz. Embodiments of the wireless heating devices may be designed for nearly any frequency; however, as mentioned above, there are numerous benefits to many existing frequency bands that are in wide market use today. For many of the previously mentioned embodiments of wireless heating devices throughout this document the current most effective frequency range is between 10 KHz and 100 MHz and can be dependent on the application of the wireless heating device.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase exists in at least one implementation of the present technology, and may exist in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. §112(f) will begin with the words “means for”, but use of the term “for” in any other context is not intended to invoke treatment under 35 U.S.C. §112(f). Accordingly, the applicant reserves the right to pursue additional claims after filing this application to pursue such additional claim forms, in either this application or in a continuing application.

I/we claim:

1. A method for heating a liquid solution in a disposable cup, the method comprising:
distributing the disposable cup,
wherein the disposable cup is configured to receive a wireless heating element at the bottom of the cup;
distributing a wireless heating element,
wherein the wireless heating element is attached to a wireless receiver configured to receive electrical or magnetic waves from a transmitter,
wherein the wireless heating element is configured to convert the received electrical or the received magnetic waves into thermal energy,
providing instructions for using the wireless heating element to heat the liquid solution in the disposable cup; and
transmitting an electrical or magnetic wave,
wherein the electrical or magnetic wave causes a portion of the wireless heating element to increase in temperature.

2. The method of claim 1, wherein the disposable cup is partially composed of paper.

3. The method of claim 1, wherein the liquid solution is partially coffee or tea.

4. The method of claim 1, wherein the transmitting electrical or magnetic energy includes near filed wireless transmission of electrical energy at a resonate frequency for the wireless heating element.

5. The method of claim 1, wherein the providing instructions for using the wireless heating element to heat the liquid solution in the disposable cup further comprises:
providing instructions for a user to attach the wireless heating element to the disposable cup;
providing instructions for the user to place the disposable cup in an area where the disposable cup receives the transmitting electrical or magnetic waves.

6. A system comprising:
a target surface; and
a wireless heating unit configured to receive magnetic waves from a transmitter and configured to convert electrical current into thermal energy,
wherein the wireless heating unit is configured to be attachable to the target surface,
wherein the wireless heating unit includes a resistor, capacitor, and an inductor.

7. The system of claim 6, wherein the target surface is a container and the wireless heating unit is located at the bottom of the container.

8. The system of claim 6, wherein the target surface is a container and the wireless heating unit is a sleeve that at least partially surrounds the container.

9. The system of claim 6, further comprising:
a laminate layer partially surrounding the wireless heating unit.

10. The system of claim 6, further comprising:
a light emitting diode (LED) configured to emit light when the wireless heating unit receives magnetic waves from the transmitter.

11. The system of claim 6, wherein the wireless heating unit includes a printed flexible circuit.

12. The system of claim 6, wherein the wireless heating unit is configured to heat non-uniformly so that part of the wireless heating unit heats to a higher temperature than another part of the wireless heating unit.

13. The system of claim 6, wherein the resistor emits heat.

14. A method for wirelessly heating a container, the method comprising:
distributing a circuit configured to attach to the container, wherein the circuit includes:
a heating element,
a wireless receiver configured to receive electrical or magnetic waves from a transmitter;
distributing the container,
wherein the container is configured to attach to the circuit;
providing instructions for attaching the circuit to the container; and
transmitting an electrical or magnetic wave,
wherein the electrical or magnetic wave causes the circuit to convert electrical energy into thermal energy.

15. The method of claim 14, further comprising:
wherein converting electrical energy into thermal energy includes receiving an electrical wave at a resonant frequency for the circuit.

16. The method of claim 14, wherein the circuit is configured to attach to the bottom of the container.

17. The method of claim 14, wherein the circuit is configured to not reach above a maximal temperature attainable within the heating element in the presence of an alternating magnetic field.

18. The method of claim 14, wherein the circuit is a printed flexible circuit.

19. The method of claim 14, wherein the circuit has a diameter ranging from 1 cm to 10 cm and a thickness ranging from 0.05 mm to 10 mm.

20. A target surface comprising:
a wireless heating element configured to receive magnetic waves from a transmitter and to convert electrical current into thermal energy,
wherein the wireless heating element is integrated into or attached onto a surface of the heatable unit,
wherein the wireless heating element includes a resistor, capacitor, and an inductor,
wherein the wireless heating element includes a printed flexible circuit, and
wherein a laminate layer partially surrounding the wireless heating element; and
a light emitting diode (LED) configured to emit light when the wireless heating element receives magnetic waves form the transmitter.
